(19) United States
(12) Patent Application Publication
(10) Pub. No.: US 2013/0206737 A1
(43) Pub. Date: Aug. 15, 2013

(54) SYSTEM AND METHOD FOR REMOVING A STATOR VANE

(71) Applicants: James Bradford Holmes, Fountain Inn, SC (US); Jason Matthew Clark, Loveland, OH (US)

(72) Inventors: James Bradford Holmes, Fountain Inn, SC (US); Jason Matthew Clark, Loveland, OH (US)

(73) Assignee: GENERAL ELECTRIC COMPANY, Schenectady, NY (US)

(21) Appl. No.: 13/369,469

(22) Filed: Feb. 9, 2012

(51) Int. Cl. B23P 19/04; B23K 26/00

(52) U.S. Cl. 219/121.67; 29/426.1; 29/700

(57) ABSTRACT

A system for removing a stator vane includes a platform, a cutting tool connected to the platform, and a sliding connection between the cutting tool and the platform. The system further includes means for advancing the cutting tool with respect to the platform. A method for removing a stator vane includes positioning a platform inside a casing that surrounds at least a portion of the stator vane. The method further includes pivoting a cutting tool with respect to the platform, sliding the cutting tool in a plane with respect to the stator vane, and cutting the stator vane with the cutting tool.

### FIELD OF THE INVENTION

The present invention generally involves a system and method for removing a stator vane. In particular, embodiments of the present invention may facilitate an indexed removal of stator vanes in a compressor without requiring removal of the rotor.

### BACKGROUND OF THE INVENTION

Compressors are widely used in industrial and commercial operations. For example, a typical commercial gas turbine used to generate electrical power includes a compressor at the front, one or more combustors around the middle, and a turbine at the rear. A casing generally surrounds the compressor to contain a working fluid flowing through the compressor, and alternating stages of rotating blades and stator vanes inside the casing progressively impart kinetic energy to the working fluid to produce a compressed working fluid at a highly energized state. Each rotating blade may be releasably connected to a rotor located along an axial centerline of the compressor, and each stator vane may be attached to one or more stator segments that circumferentially surround the rotor. The stator segments may in turn be releasably connected to the casing.

Periodically, the stator vanes in the compressor must be removed and/or replaced. Doing so typically requires at least partial removal of the casing surrounding the compressor to provide access to the stator vanes and stator segments. With the rotor still in place, however, access to the stator vanes is somewhat restricted, and particular care must be taken to ensure that removal of the stator vanes does not result in collateral damage to the rotor, casing, or adjacent rows of rotating blades. For example, a pneumatic or electric grinder or cutting wheel may be manually inserted around the rotor to individually cut each stator vane, and the stator vanes and stator segments may then be removed from the casing. Although effective at minimizing or preventing collateral damage to adjacent components, the restricted access and use of a grinder or cutting wheel may take one hour or more to cut each stator vane. As a result, an improved system and method for removing compressor stator vanes that reduces the required time without risking collateral damage would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for removing a stator vane. The system includes first means for cutting the stator vane, second means for guiding the first means along a plane with respect to the stator vane, and third means for positioning the first means with respect to the stator vane.

Another embodiment of the present invention is a system for removing a stator vane that includes a platform, a cutting tool connected to the platform, and a sliding connection between the cutting tool and the platform. The system further includes means for advancing the cutting tool with respect to the platform.

The present invention may also include a method for removing a stator vane that includes positioning a platform inside a casing that surrounds at least a portion of the stator vane. The method further includes pivoting a cutting tool with respect to the platform, sliding the cutting tool in a plane with respect to the stator vane, and cutting the stator vane with the cutting tool.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a side view of an exemplary compressor with a portion of the casing removed;

FIG. 2 is an axial cross-section of the exemplary compressor shown in FIG. 1 taken along line A-A;

FIG. 3 is a perspective view of a system for removing a stator vane according to one embodiment of the present invention;

FIG. 4 is a flow diagram of a method for removing a stator vane according to one embodiment of the present invention;

FIG. 5 is a perspective view of the system shown in FIG. 3 removing the first stator vane in a stator segment;

FIG. 6 is an enlarged perspective view of a portion of the system shown in FIG. 3 in a retracted position;

FIG. 7 is an enlarged perspective view of a portion of the system shown in FIG. 3 in an intermediate position;

FIG. 8 is an enlarged perspective view of a portion of the system shown in FIG. 3 in an extended position; and

FIG. 9 is a perspective view of the system shown in FIG. 3 removing the sixth stator vane in the stator segment.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for removing a compressor stator vane. The system generally includes a cutting tool attached to a platform, and the platform may be precisely located and/or indexed with respect to the next stator vane to be removed. A sliding connection between the cutting tool and the platform reliably guides the cutting tool along the shape and contour of the stator vane without inadvertently contacting and/or damaging adjacent components such as a rotor or rotating blades. As a result, the systems and methods disclosed herein may utilize cutting tools that can completely cut through the stator vanes in less time, with less risk to the adjacent components, and/or without requiring removal of the rotor and/or rotating blades. Although exemplary embodiments of the present invention will be described generally in the context of a compressor stator vane for purposes of illustration, one of ordinary skill in the art will readily appreciate that embodiments of the present invention are not limited to removing compressor stator vanes unless specifically recited in the claims.

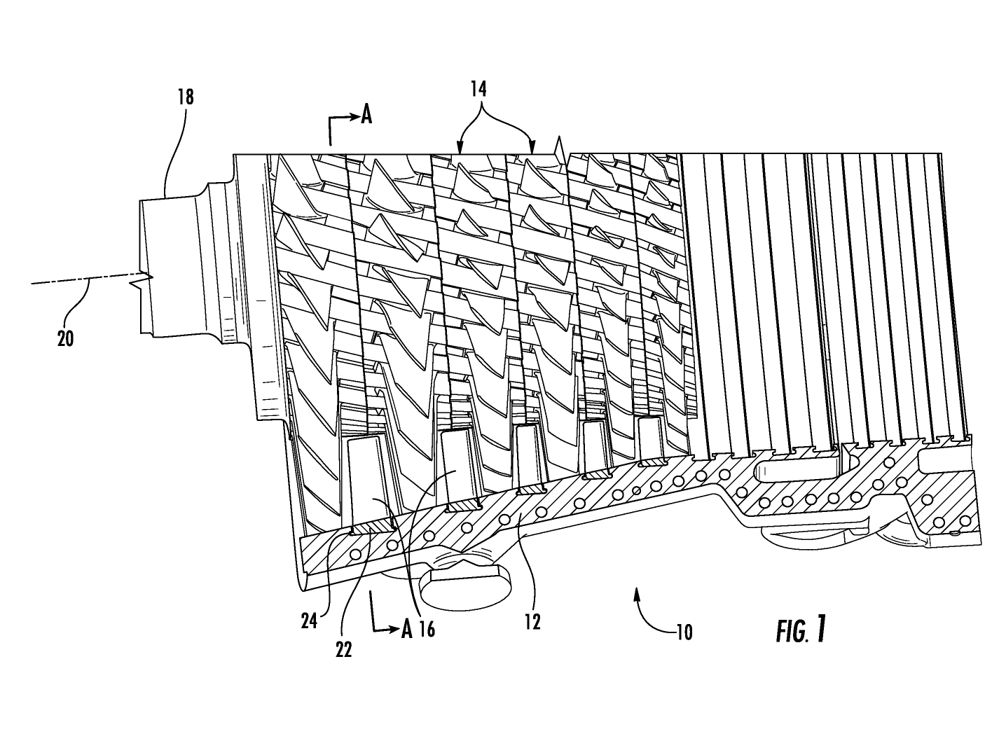

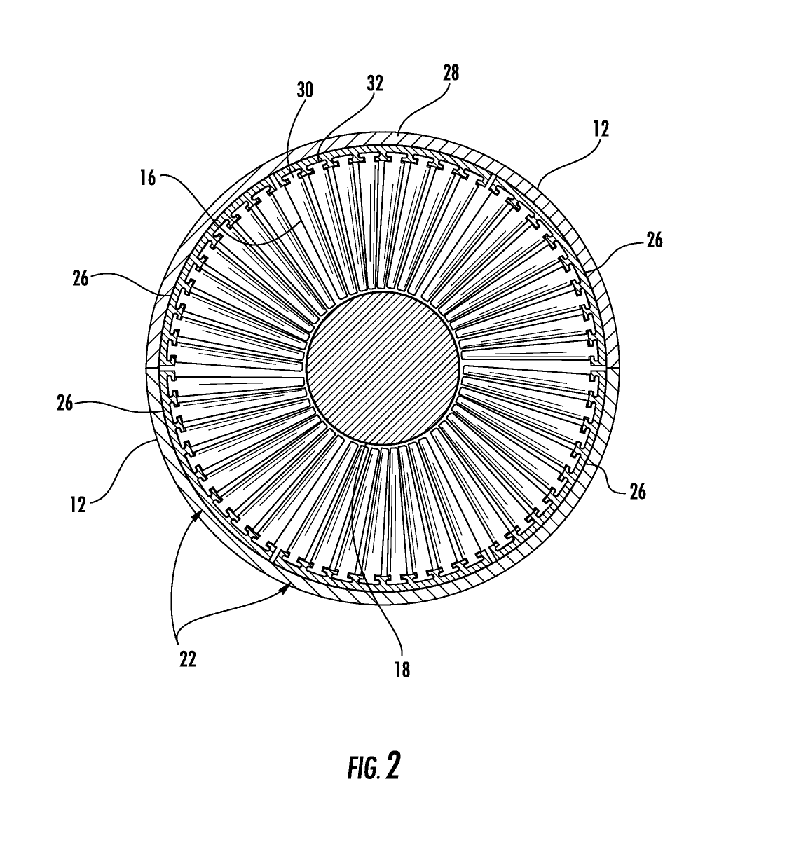

FIG. 1 provides a side view of an exemplary compressor 10, and FIG. 2 provides an axial cross-section view of the exemplary compressor 10 shown in FIG. 1 taken along line A-A. A casing 12 that generally surrounds the compressor 10 has been partially removed from FIG. 1 to reveal that the compressor 10 includes alternating stages of rotating blades 14 and stator vanes 16 inside the casing 12. Each rotating blade 14 may be releasably connected to a rotor 18 located along an axial centerline 20 of the compressor 10, and each stator vane 16 may be fixedly attached to a stator segment 22. As shown most clearly in FIG. 1, the casing 12 may include a hook fit slot 24 that extends circumferentially around the casing 12 for each stage of stator vanes 16, and the stator segments 22 may releasably slide into the hook fit slots 24. Referring to FIG. 2, the compressor 10 may include, for example, six stator segments 22 that circumferentially surround the rotor 18, with each half of the casing 12 holding two side stator segments 26 and one center stator segment 28. Each stator vane 16 may in turn include a dovetail extension 30 that axially slides into a complementary dovetail slot 32 in the stator segments 22 to securely hold the stator vanes 16 in place with respect to the rotor 18. In this manner, the rotor 18 may turn each stage of rotating blades 14 while the casing 12 and stator segments 22 hold each stage of stator vanes 16 in place.

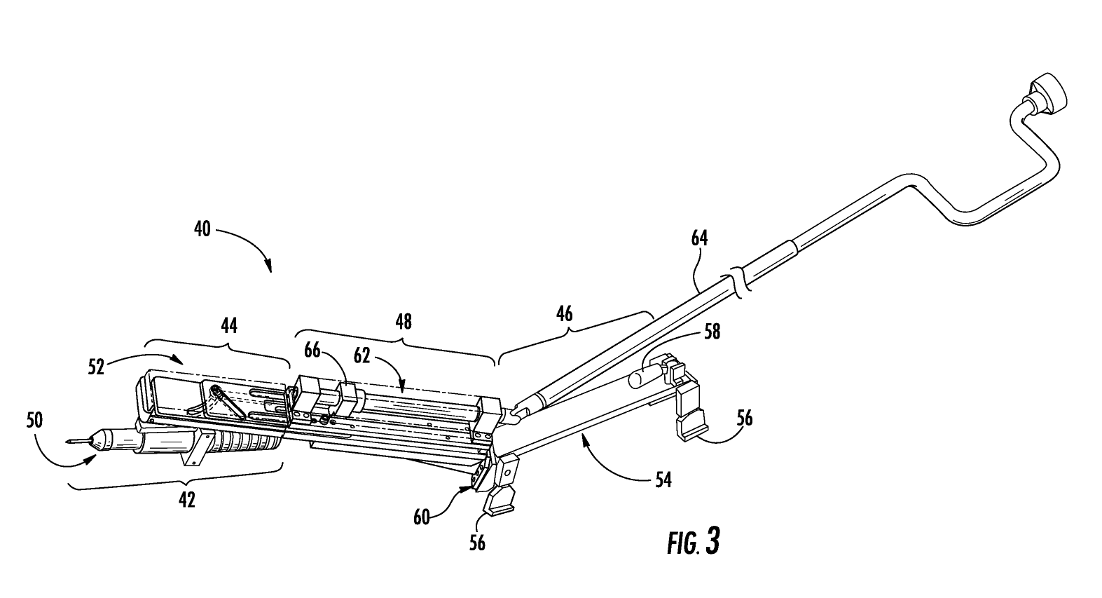

FIG. 3 provides a perspective view of a system 40 for removing stator vanes 16 according to one embodiment of the present invention. As shown, the system 40 generally includes first means 42 for cutting the stator vane 16, second means 44 for guiding the first means 42 with respect to the stator vane 16, third means 46 for positioning the first means 42 with respect to the stator vane 16, and fourth means 48 for advancing the first means 42 with respect to the third means 48.

The function of the first means 42 is simply to cut through the stator vane 16, thereby allowing removal of the stator vane 16. The structure associated with the first means 42 includes any cutting tool 50 capable of cutting through the stator vane 16. For example, the cutting tool 50 may include a pneumatic or electric grinder or a cutting wheel as is well known in the art. Alternately, the cutting tool 50 may include a laser, an electron discharge machine, a plasma torch, an oxygen lance, or similar high energy device that can reduce the time required to cut through the stator vane 16.

The function of the second means 44 is to guide the first means 42 with respect to the stator vane 16. For example, the second means 44 may guide the first means 42 axially, radially, and/or circumferentially inside the compressor 10 with respect to the stator vane 16. In particular embodiments, the second means 44 may guide the first means 42 in a single plane with respect to the stator vane 16. In this manner, the second means 44 may maneuver the first means 42 to a desired angle and/or distance and/or along a desired path with respect to the stator vane 16 to enhance the speed and efficiency of the cutting. The structure associated with the second means 44 may include, for example, a mechanical template, a bracket, or a sliding connection 52 that guides the first means 42 with respect to the stator vane 16.

The function of the third means 46 is to position or locate the first means 42 with respect to the stator vane 16. In particular embodiments, the third means 46 may index the first means 42 to a particular position with respect to the stator vane 16 so that the second means 44 may more efficiently guide or maneuver the first means 42 with respect to the stator vane 16. The structure for the third means 46 may include a truck, a stand, or a platform 54. In particular embodiments, the third means 46 may be in sliding engagement with the casing 12 that surrounds at least a portion of the stator vane 16. For example, as shown in FIG. 3, the platform 54 may include one or more fittings 56 adapted to ride inside the hook fit slot 24 shown in FIG. 1. Alternately or in addition, a lock 58 may be connected to the platform 54 to engage with the casing 12 and hold the platform 54 fixedly in place with respect to the casing 12. The lock 58 may include, for example, a retractable pin, clamp, or other device that engages with the casing 12 and/or provides a friction fit between the platform 54 and hook fit slot 24.

As further shown in FIG. 3, the system 40 may include a pivotal connection 60 between the second means 44 and the third means 46. The pivotal connection 60 may include a hinge or other articulated feature that allows the second means 44 to pivot with respect to the third means 46. In this manner, the second means 44 may pivot with respect to the third means 46 to adapt as the curvature of the casing 12 and/or rotor 18 varies between stator vane 16 stages.

The function of the fourth means 48 is to advance or move the first means 42 with respect to the third means 48. The structure for the fourth means 48 may include any electrical, mechanical, or electro-mechanical device known in the art for moving one component with respect to another. For example, the structure may include an acme screw, a piston, a servo-motor, or other extendable connection 62, as shown in FIG. 3. During operation, an operator may be connected to the extendable connection 62 to operate the extendable connection 62. For example, as shown in FIG. 3, a handle 64 connected to the extendable connection 62 may be rotated to advance a collar 66. The collar 66 may in turn be operably connected to the first and/or second means 42, 44 to advance or move the first means 42 with respect to the third means 48.

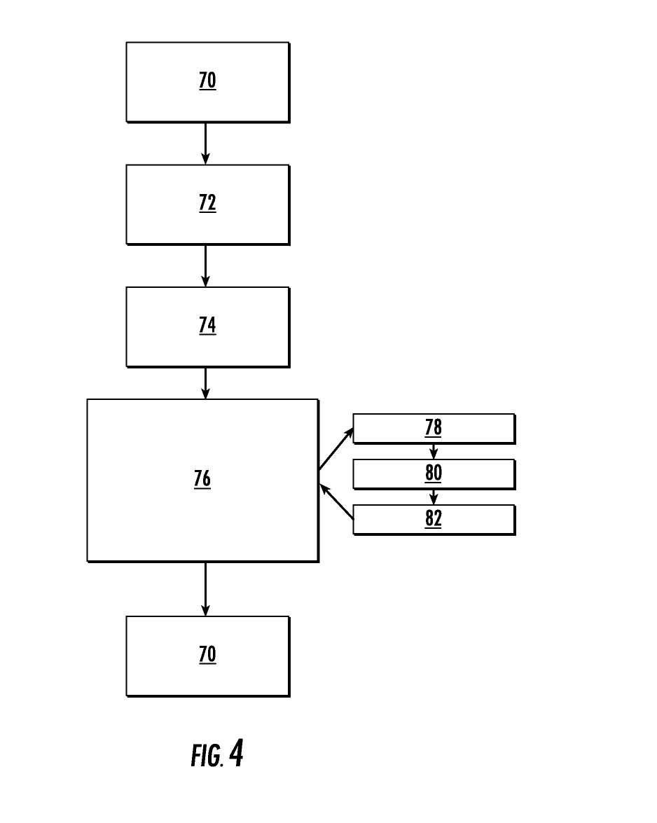

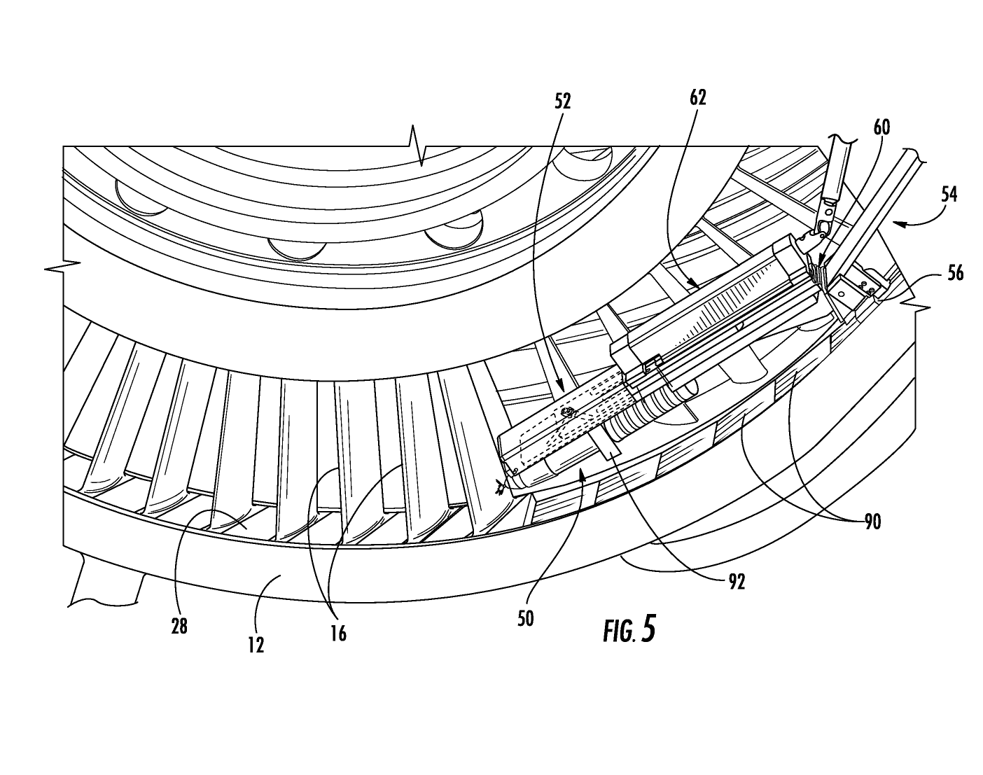

FIG. 4 provides a flow diagram of a method for removing the stator vane 16 according to one embodiment of the present invention, and FIGS. 5-9 illustrate various positions of the system 40 shown in FIG. 3 during removal of the stator vane 16. At block 70, the method generally commences with partial or complete removal of the casing 12 to provide access inside the compressor 10. At block 72, the stator vanes 16 in the side stator segments 26 are cut using conventional systems and methods known in the art. For example, an operator may manually position and manipulate a pneumatic or electric grinder or a cutting wheel to cut the stator vanes 16 in the side stator segments 26, as is well known in the art. Alternately, the operator may use a laser, an electron discharge machine, a plasma torch, an oxygen lance, or similar high energy device that can reduce the time required to cut through the stator vane 16. At block 74, the side stator segment 26 is removed from the casing 12 once all of the stator vanes 16 in the side stator segment 26 have been removed. At block 76, the method uses the system 40 shown in FIGS. 3 and 5-9 to remove the stator vanes 16 in the center stator segment 28.

At block 78, the method positions and/or indexes the system 40 with respect to the next stator vane 16 to be cut. Referring to FIG. 5, for example, the operator may insert one or more spacers 90 into the hook fit slot 24 adjacent to the next stator vane 16 to be cut and/or the center stator segment 28. The operator may then slide the platform 54 inside the hook fit slot 24 until the platform 54 abuts the spacers 90 so that the spacers 90 are between the stator vane 16 and the platform 54. If present and desired, the operator may engage the lock 58 previously shown and described with respect to FIG. 3. As shown in FIG. 5, the particular number and size of the spacers 90 may be selected to precisely locate or index the cutting tool 50 at a particular distance from the next stator vane 16 to be cut. In addition, the system 40 may include a bar or other extension 92 that rests on the spacers 90 or center stator segment 28 to pivot the cutting tool 50 the correct amount with respect to the platform 54 to match the curvature of the casing 12 and center stator segment 28 for the particular stage being cut.

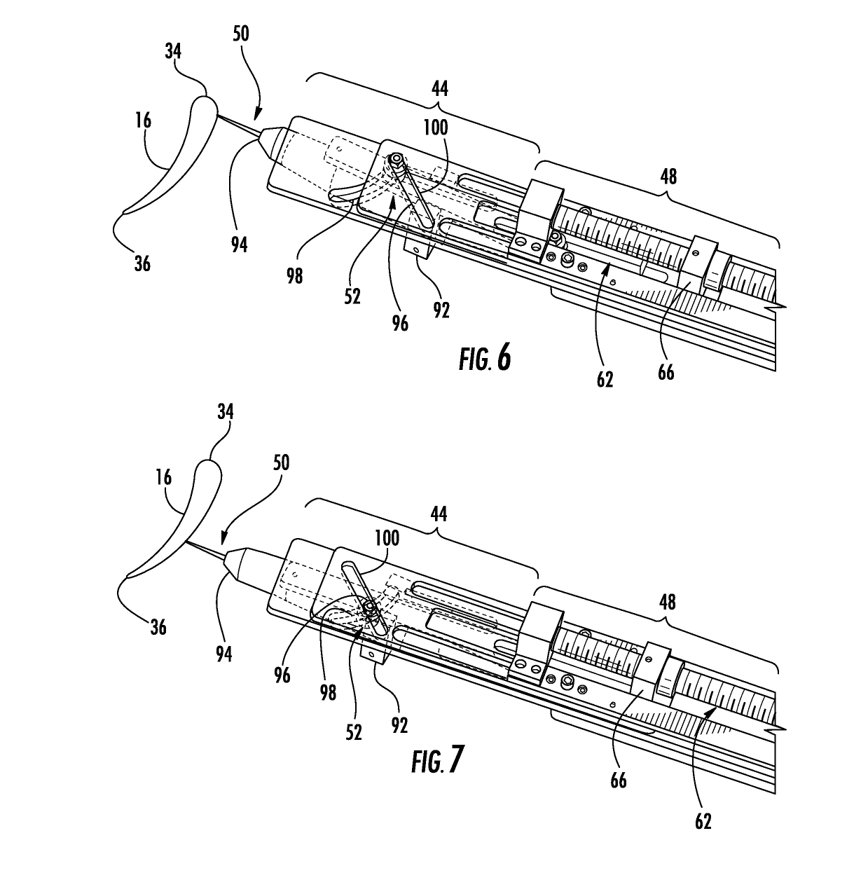

Returning to FIG. 4, at block 80, the method cuts the next stator segment 16, and FIGS. 6-8 provide enlarged perspective views the system 40 in various positions to illustrate the function and operation of the first, second, and fourth means 42, 44, 48 while cutting the stator vane 16. As shown in FIGS. 6-8, the cutting tool 50 of the first means 42 may include a plasma torch 94, and the sliding connection 52 of the second means 44 may be engaged between the cutting tool 50 and the platform 54. Although one of ordinary skill in the art can assemble multiple different sliding connections 52, in the particular embodiment shown in FIGS. 6-8, the sliding connection 52 includes a pivot 96 in sliding engagement with a curved slot 98 and a straight slot 100. The pivot 96 may be fixedly connected to the cutting tool 50, the curved slot 98 may be fixedly connected to the third and/or fourth means 46, 48, and the straight slot 100 may be fixedly connected to the collar 66.

In FIG. 6, the third means 46 has positioned or indexed the cutting tool 50 to begin cutting a leading edge 34 of the stator vane 16, as previously shown and described with respect to FIG. 5, and the second means 44 is in a retracted position with respect to the stator vane 16. In this retracted position, the pivot 96 is at first ends 102 of both the curved slot 98 and the straight slot 100.

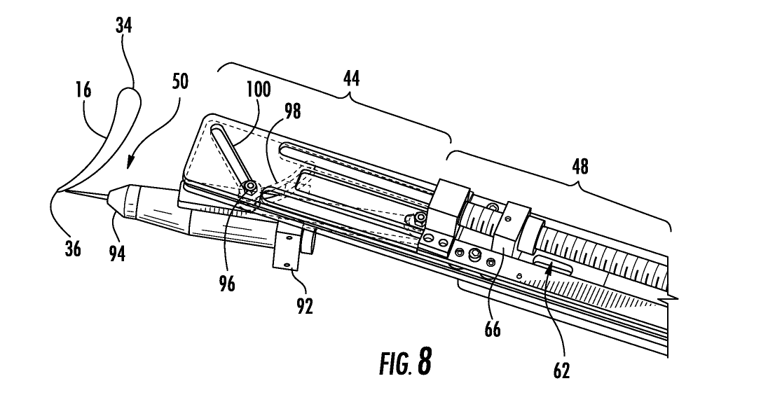

In FIG. 7, the cutting tool 50 has cut a portion of the stator vane 16, and the second means 44 has guided the cutting tool 50 to a mid-position with respect to the stator vane 16. As shown, the fourth means 48 has been operated to advance the first means 42 with respect to the third means 46. Specifically, the extendable connection 62 has been rotated to advance the collar 66 away from the platform 54. As the collar 66 moved away from the platform 54, the fixed connected between the collar 66 and the straight slot 100 caused the straight slot 100 to also move away from the platform 54. As the straight slot 100 moved away from the platform 54, the straight slot 100 pushed the pivot 96, and thus the cutting tool 50, away from the platform 54 and toward a trailing edge 36 of the stator vane 16. Simultaneously, the curvature of the curved slot 98 adjusts the movement of the pivot 96, and thus the cutting tool 50, both away from the platform 54 and toward the trailing edge 36 of the stator vane 16.

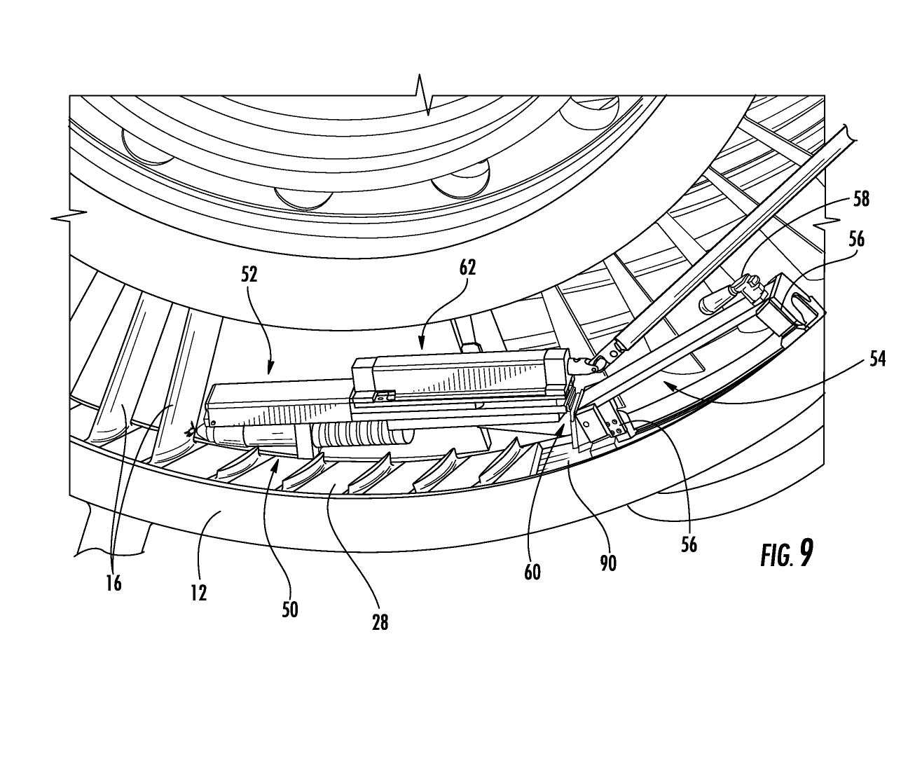

In FIG. 8, the second means 44 has guided the first means 42 to an extended position with respect to the stator vane 16. Specifically, the extendable connection 62 has been additionally rotated to advance the collar 66 further away from the platform 54 so that the pivot 96 is at second ends 80 of both the curved slot 98 and the straight slot 100. In this manner, the combined effect of the pivot 96, curved slot 98, and straight slot 100, as shown in FIGS. 6-8, guides the cutting tool 50 in a single plane to follow the curvature of the stator vane 16 along the length of the stator vane 16.

Returning to FIG. 4, at block 82, the method removes the system 40 from the compressor 10. Specifically, the operator may slide the platform 54 out of the hook fit slot 24 and remove one or more spacers 90 from the hook fit slot 24 in preparation for cutting the next stator vane 16 in the center stator segment 28. The method then repeats the steps in blocks 78, 80, and 82 to cut additional stator vanes 16 from the center stator segment 28. For example, as shown in FIG. 9, the system 40 has previously cut five stator vanes 16 in the center stator segment 28, and the operator has inserted a single spacer 90 between the center stator segment 28 and the platform 54 in the hook fit slot 24. As a result, the operator has indexed the cutting tool 50 to the sixth stator vane 16 in the center stator segment 28, and the first, second, and fourth means 42, 44, 48 may again be operated as previously shown and described with respect to FIGS. 6-8 to cut the sixth stator segment 16.

The operator may repeat the steps described with respect to blocks 78, 80, and 82 until all stator vanes 16 in the center stator segment 28 have been cut. One of ordinary skill in the art will readily appreciate that the embodiments of the present invention may be applied equally effectively from either side of the center stator segment 28. Specifically, if desired, the operator may cut one or more stator vanes 16 from one side of the center stator segment 28 and cut the remaining stator vanes 16 from the other side of the center stator segment 28 to enhance access to the stator vane 16 being cut. Of course, adjustments may be made to the second means 44, depending on the shape and contour of the stator vanes 16 and side of the stator vane 16 facing the system 40, to ensure that the cutting tool 50 continues to be guided as desired along the contour of the stator vane 16.

Once all stator vanes 16 have been removed from the center stator segment 28, the center stator segment 28 may be removed from the casing 12, as shown by block 84 in FIG. 4. It is anticipated that embodiments of the present invention utilizing a laser, an electron discharge machine, a plasma torch, an oxygen lance, or similar high energy device can reduce the time required to cut through each stator vane 16 to approximately 5-10 minutes. As a result, the system 40 and method disclosed herein may reduce the time required to remove all stator vanes in a compressor by 80% or more, potentially saving 24-36 hours per compressor outage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for removing a stator vane, comprising:
a. first means for cutting the stator vane;
b. second means for guiding said first means along a plane with respect to the stator vane; and
c. third means for positioning said first means with respect to the stator vane.

2. The system as in claim 1, wherein said first means comprises a plasma torch.

3. The system as in claim 1, wherein said second means comprises a pivot in sliding engagement with a curved slot and a straight slot.

4. The system as in claim 1, further comprising an extendable connection operably engaged with at least one of said first or second means.

5. The system as in claim 1, wherein said third means comprises a platform in sliding engagement with a casing that surrounds at least a portion of the stator vane.

6. The system as in claim 1, further comprising a lock connected to said third means, wherein said lock is configured to engage a casing that surrounds at least a portion of the stator vane.

7. The system as in claim 1, further comprising one or more spacers between the stator vane and said third means.

8. The system as in claim 1, further comprising a pivotal connection between said second means and said third means.

9. A system for removing a stator vane, comprising:
a. a platform;
b. a cutting tool connected to said platform;
c. a sliding connection between said cutting tool and said platform; and
d. means for advancing said cutting tool with respect to said platform.

10. The system as in claim 9, wherein said platform comprises a fitting adapted to ride inside a slot in a casing that surrounds at least a portion of the stator vane.

11. The system as in claim 9, further comprising a lock that releasably connects said platform to a casing that surrounds at least a portion of the stator vane.

12. The system as in claim 9, wherein said cutting tool comprises a plasma torch.

13. The system as in claim 9, further comprising a pivotal connection between said platform and said cutting tool.

14. The system as in claim 9, wherein said sliding connection comprises a curved slot and a straight slot pivotally connected to said cutting tool.

15. The system as in claim 9, wherein said means for advancing said cutting tool with respect to said platform comprises an extendable connection.

16. The system as in claim 9, further comprising one or more spacers between the stator vane and said platform.

17. A method for removing a stator vane, comprising:
a. positioning a platform inside a casing that surrounds at least a portion of the stator vane;
b. pivoting a cutting tool with respect to said platform;
c. sliding said cutting tool in a plane with respect to the stator vane; and
d. cutting the stator vane with said cutting tool.

18. The method as in claim 17, further comprising indexing said platform with respect to the stator vane.

19. The method as in claim 17, further comprising locking said platform to a casing that surrounds at least a portion of the stator vane.

20. The method as in claim 17, further comprising sliding said cutting tool away from said platform while cutting the stator vane.
